(19) United States
(12) Patent Application Publication
(10) Pub. No.: US 2017/0221307 A1
(43) Pub. Date: Aug. 3, 2017

(54) ONLINE GAME

(71) Applicant: Talla Thiam, Oklahoma City, OK (US)

(72) Inventor: Talla Thiam, Oklahoma City, OK (US)

(21) Appl. No.: 15/012,685

(22) Filed: Feb. 1, 2016

(51) Int. Cl. G07F 17/32

(52) U.S. Cl. CPC G07F 17/3255; G07F 17/323

(57) ABSTRACT

An online game allows people or businesses to post their ads for a certain amount of time. Users can be players and can post ads. The users can have an account having funds/money. The ads can be listed for a period of time called a listing period. The ad poster will put money from their account in a purse as a prize. Then, the players using the web site can play a game and at the end of the listing period the highest scorer or scorers will win the purse money.

### CROSS REFERENCE TO RELATED APPLICATIONS

Not applicable.

### STATEMENT REGARDING FEDERALLY SPONSORED RESEARCH OR DEVELOPMENT Not applicable.

### FIELD OF THE INVENTION

The present invention relates to an online game that allows people or businesses to post their ads for a certain amount of time, and wherein users can be players and can post ads; and wherein a game can be played to determine a winner or winners.

### BACKGROUND OF THE INVENTION

It is a problem in the art to provide advertising at a reasonable price. It is a further problem to attract visitors to view advertising on a web site.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an online game that allows people or businesses to post their ads for a certain amount of time. Users can be players and can post ads. The users can have an account having funds/money. The ads can be listed for a period of time called a listing period. The ad poster will put money from their account in a purse as a prize. Then, the players using the web site can play a game and at the end of the listing period the highest scorer or scorers will win the purse money.

More specifically, the present invention provides an online game for supporting advertising and having users who can be players, including:

a website hosting at least one competitive game, said website operating a purse which holds funds, said website being adapted to carry advertisements; said website including user accounts for distributing funds to said purse and for receiving funds from said purse; and wherein said users can be players

a competitive game operated on said website for a plurality of players, said competitive game providing player scores and having an outcome wherein at least one player wins funds from said purse; said game being run for a predetermined period of time;

a processor and memory for operating said at least one competitive game for said website, for allowing individuals and businesses to post advertisements on said website for said predetermined amount of time; and wherein users of said website can be players who can post ads, and wherein said users can have an account for receiving and disbursing funds;

said advertisements being listed on said website for said predetermined period of time which is a listing period; and wherein during operation of said competitive game said advertisement poster will disburse funds from their account into said purse as a prize, after which said players using said website can play at least one game, and wherein at an end of said listing period a highest scoring player wins said purse money.

Other objects and advantages of the present invention will be more readily apparent from the following detailed description when read in conjunction with the accompanying drawings.

### BRIEF DESCRIPTION OF THE DRAWINGS

FIG. 1 is a schematic diagram illustrating communication between a website, users of the website, and hardware elements.

FIG. 2 is a flowchart illustrating steps used in the method of the present invention.

### DETAILED DESCRIPTION OF THE INVENTION

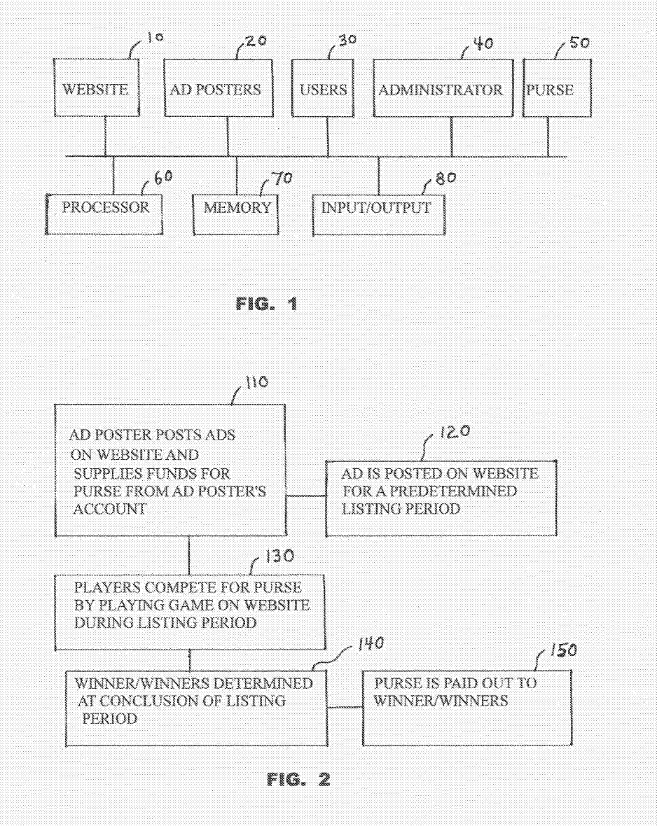

FIG. 1 is a schematic diagram illustrating communication between a website 10, advertisement posters 20 (also referred to herein as “ad posters 20”), users 30 of the website, an administrator 40, a purse 50 which is a financial purse, a processor 60, a memory 70, and input/output section 80. The processor 60, the memory 70, and the input/output section 80 and hardware elements. The communication link schematically shown in FIG. 1 is to illustrate a connection, which is contemplated to include users that are widely separated communicating with the website by telecommunications links such as the internet, the world wide web, cell phones, landlines, and so on.

The administrator 40 operates the website 10. Each ad poster 20 has their own account, which is used to supply funds to the purse. When the ad poster 20 wishes to advertise on the website 10, then funds are transferred from the ad poster's account to the purse 50, for the purposes described further hereunder.

FIG. 2 is a flowchart illustrating steps used in the method of the present invention. In the following, it will be understood that the steps are carried out in software, and that the website includes the capability of running the software necessary to carry out the steps, as shown schematically in FIG. 1 by the hardware elements that include the processor 60, the memory 70, and the input/output section 80, which together are capable of running the software necessary to carry out the steps shown in FIG. 2. Specifically, in FIG. 2, in step 110 an ad poster 20 posts ads on the website 10, and supplies funds for the purse 50 from the ad poster's account. At step 120, an ad is posted on the website 10 for a predetermined listing period, the ad being provided by the ad poster. The ad appears on the website 10, and is viewed by the users 30. The group of users 30 includes both players and ad posters, who may view the website 10 and the ads posted on the website 10. The ad can be provided by the ad poster(s) 20, and can also be provided by the administrator and by third parties when so permitted by the administrator 40.

At step 130, the players from the group of users 30 compete on the website for the purse 50, by playing a game on the website 10 during the predetermined listing period. At step 140, a winner or winners are determined at the conclusion of the predetermined listing period. At step 150, the purse is paid out to the winner or winners. There can be a single winner, or there can be multiple winners, as is known and typical in competitive contests and sports.

A further discussion of the present invention is as follows.

The invention includes setting up the website 10 in which people can post their ads for a certain amount of time, i.e. the predetermined period of time. The persons posting ads (i.e. the ad posters 20) do not need to be players, and do not need to be members or users 30 of the website 10. Users of the website 10 can be players or can be viewers who watch the games and/or view the ads. Users 30 can also post ads. Further, the persons advertising and/or the players can have an account having funds/money. The ads can be listed for a period of time called a listing period, i.e. the predetermined listing period.

The ad poster 20 will put money from their account into a purse 50. Here, the term “purse” is used in the sense of a prize, rather than a physical object. Then, the players using the web site can play a game as shown at step 130 (which can be any of a trivia game, an electronic game, or other type of competitive game) and at the end of the predetermined listing period the highest scorer (or alternatively the two highest scorers or three highest scorers, etc.) will win the money in the purse 50. The specific number of places winning prizes (i.e. first, second, third, etc.) will be decided by the website administrator 40. In an alternative version of the present invention, the specific number of places winning prizes is set by the ad poster 20.

As one preferred further embodiment, the advertisement poster 20 will choose his/her own advertising campaign: it can be a global advertising campaign—in this case any person anywhere on the planet can play the game or games, a national campaign wherein only people from one particular country can play the game(s), a multi-national campaign wherein only people from selected countries will be allowed to play the game(s), a City campaign wherein only people from that selected city will be able to play the game or games, or a regional campaign wherein only people from one particular region will be able to play the game(s).

The present invention is useful such that it will help a person or company wishing to advertise a product or service. By the present invention, such person or company does not have to pay a relatively large amount of money to some company for advertising, and instead they will be able to choose how much they wish to put into the above-noted purse, for example it can preferably be in a range of $15 to $800, or can be a greater or lesser amount. The ability of the ad poster 20 to set their own purse amount is another aspect of the present invention.

In a nutshell the advertiser (i.e. the ad poster 20) will choose how much he or she wants to put into the purse 50. The website operator (i.e. the administrator 40) can choose whether or not to set a minimum amount of money to put in the purse 50. Also, the purse 50 does not go to the website operator (administrator 40) but rather it goes to the winners (indicated at steps 140 and 150 of FIG. 2).

Since people who play the game or games of the present invention will have a chance to compete as well as win money, the advertisement is expected to be highly attractive to a number of people. That is, the money in the purse 50 will ensure a number of viewers. Before they play the game or games, the user 30 (that is, the person competing to win the purse 50) can be required to read, listen to, or watch an advertisement. The advertisement is on behalf of the person or company that has provided the purse, in a preferred embodiment. Alternatively there could be a collection of ads for a number of persons/companies providing purses. The ad can be a sentence or text, an audio or a video; and it can be of any selected length as determined by the site operator and can depend for example on the amount of money in the purse.

Also by choosing the advertisement campaign (Worldwide or Global, national, multi-national, and so on), the advertiser will select his/her market which is a great and precise way to advertise a product(s) or service(s). Right now, on the Internet, if one posts an advertisement on a website, they cannot select their market because anybody with Internet access can see their Ad if they go to the page where the Advertisement is posted. This may be important for services/products specific to one or more countries or regions; and/or to comply with laws of individual countries or regions.

Additionally, in the present invention, since there is a competition for the purse 50 that has a predetermined time frame as noted above, players may come to the Advertisement page more often to see who's the leader and what their rank is at some point in the competition. That means more exposure for the Advertisements on the website 10.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An online game for supporting advertising and having users who can be players, comprising:
a website hosting at least one competitive game, said website operating a purse which holds funds, said website being adapted to carry advertisements; said website including user accounts for distributing funds to said purse and for receiving funds from said purse; and
wherein said users can be players a competitive game operated on said website for a plurality of players, said competitive game providing player scores and having an outcome wherein at least one player wins funds from said purse; said game being run for a predetermined period of time;
a processor and memory for operating said at least one competitive game for said website, for allowing individuals and businesses to post advertisements on said website for said predetermined amount of time; and wherein users of said website can be players who can post ads, and wherein said users can have an account for receiving and disbursing funds;
said advertisements being listed on said website for said predetermined period of time which is a listing period; and wherein during operation of said competitive game said advertisement poster will disburse funds from their account into said purse as a prize, after which said players using said website can play at least one game, and wherein at an end of said listing period a highest scoring player wins said purse money.

2. An online game as claimed in claim 1, wherein said advertisement poster can select that an outcome of a game provides a ranking of players, and wherein a plurality of top ranking players receive funds from said purse.

3. An online game as claimed in claim 1, wherein prior to play of said competitive game, players are required to do at least one of reading said advertisement, listening to said advertisement, and watching said advertisement.

4. An online game as claimed in claim 1, wherein said advertisement can be any of a sentence of text, an audio that plays, and a video that plays; and wherein said advertisement can be of a selected length determined by said administrator, and wherein said selected length can depend on an amount of funds in said purse.

5. An online game as claimed in claim 1, wherein said competitive game can be limited to a specific set of players and users.

6. An online game as claimed in claim 5, wherein said specific set of players and users can be limited by any of the following criteria as part of an advertisement campaign: global, regional, specific nations, and multi-national.
